(19) United States
(12) Patent Application Publication
(10) Pub. No.: US 2013/0114992 A1
(43) Pub. Date: May 9, 2013

(54) Binder Apparatus and Assembly Including the Same

(71) Applicant: Janet Wheeler Sorell, Delmar, NY (US)

(72) Inventor: Janet Wheeler Sorell, Delmar, NY (US)

(21) Appl. No.: 13/672,385

(22) Filed: Nov. 8, 2012

Related U.S. Application Data
(60) Provisional application No. 61/557,194, filed on Nov. 8, 2011.

(51) Int. Cl. B42F 3/00

(52) U.S. Cl. CPC B42F 3/00
USPC 402/31

(57) ABSTRACT

An apparatus is disclosed. The apparatus includes a binder. The binder includes a front cover portion, a spine portion and a rear cover portion. The front cover portion is connected to the spine portion by a first hinge. The rear cover portion is connected to the spine portion by a second hinge. Each of the front cover portion, the spine portion and the rear cover portion define an interior surface portion and an exterior surface portion of the binder. The apparatus also includes at least one first fastener portion of a fastener arranged upon the interior surface portion of the binder. The at least one first fastener portion of the fastener is arranged upon the spine portion of the binder. An assembly is also disclosed.

### CROSS-REFERENCE To RELATED APPLICATIONS

This U.S. Patent Application claims priority to U.S. Provisional Application: 61/557,195 filed on Nov. 8, 2011, the disclosure of which is considered part of the disclosure of this application and is hereby incorporated by reference in its entirety.

### FIELD OF THE INVENTION

The disclosure relates to a binder apparatus and an assembly including the same.

### DESCRIPTION OF THE RELATED ART

Container devices are known in the art. Conventional container devices, however, are known to include mechanical components that are expensive and prone to failure, which typically results in the container not functioning adequately for its intended purpose. Accordingly, there is a need in the art to improve such devices.

### SUMMARY

One aspect of the disclosure provides an apparatus including a binder and at least one fastener portion. The binder includes a front cover portion, a spine portion and a rear cover portion. The front cover portion is connected to the spine portion by a first hinge. The rear cover portion is connected to the spine portion by a second hinge. Each of the front cover portion, the spine portion and the rear cover portion define an interior surface portion and an exterior surface portion of the binder. At least one first fastener portion of the fastener is arranged upon the interior surface portion of the binder. The at least one first fastener portion of the fastener is arranged upon the spine portion of the binder.

The fastener may be a hook-and-loop fastener. The at least one first fastener portion may be a hook portion of the hook-and-loop fastener. The at least one first fastener portion may be a loop portion of the hook-and-loop fastener.

The fastener may be a magnet. The at least one first fastener portion may be a north pole of the magnet. The at least one first fastener portion may be a south pole of the magnet.

The apparatus may also include a webbing secured to the exterior surface portion of the binder for enclosing the binder. The webbing may include a wear-resistant material. The webbing may include a liquid-resistant material. The webbing may form an opening that provides access to the binder. The webbing includes a closure arranged along the opening for providing selective access to the binder that is enclosed by the webbing.

Another aspect of the disclosure provides an assembly including a binder and at least one folder removably-connected to the binder by a fastener. The binder includes a front cover portion, a spine portion and a rear cover portion. The front cover portion is connected to the spine portion by a first hinge. The rear cover portion is connected to the spine portion by a second hinge. Each of the front cover portion, the spine portion and the rear cover portion define an interior surface portion and an exterior surface portion of the binder. At least one first fastener portion of the fastener is arranged upon the interior surface portion of the binder. The at least one first fastener portion of the fastener is arranged upon the spine portion of the binder. The at least one folder includes an exterior surface portion. At least one second fastener portion of the fastener is arranged upon the exterior surface portion of the at least one folder.

The fastener may be a hook-and-loop fastener. The at least one first fastener portion may be a hook portion, and, the at least one second fastener portion is a loop portion. The at least one first fastener portion may be a loop portion, and, the at least one second fastener portion may be a hook portion.

The fastener may be a magnet. The at least one first fastener portion may be a north pole of the magnet. The at least one second fastener portion may be a south pole of the magnet. The at least one first fastener portion may be a south pole of the magnet. The at least one second fastener portion may be a north pole of the magnet.

The assembly may include a webbing secured to the exterior surface portion of the binder for enclosing the binder. The webbing may include one or more of a wear-resistant material and a liquid-resistant material. The webbing may form an opening that provides access to the binder and the at least one folder. The webbing includes a closure arranged along the opening for providing selective access to the binder and the at least one folder that are enclosed by the webbing.

### BRIEF DESCRIPTION OF THE DRAWINGS

The disclosure will now be described, by way of example, with reference to the accompanying drawings, in which:

FIG. 1A is an exploded, perspective view of an exemplary assembly.

FIG. 1B is another exploded, perspective view of the assembly of FIG. 1A.

FIG. 2 is an assembled, side view of the assembly of FIG. 1A.

FIG. 3A is an enlarged view of the assembly of FIG. 2 according to line 3.

FIG. 3B is an enlarged view of the assembly of FIG. 2 according to line 3.

FIG. 4A is an exploded, perspective view of an exemplary assembly.

FIG. 4B is another exploded, perspective view of the assembly of FIG. 4A.

FIG. 5 is an assembled, side view of the assembly of FIG. 4A.

FIG. 6A is an enlarged view of the assembly of FIG. 5 according to line 2.

FIG. 6B is an enlarged view of the assembly of FIG. 5 according to line 2.

FIG. 7 is a perspective view of an exemplary assembly of FIGS. 1A-3B or 4A-6B including a covering.

### DETAILED DESCRIPTION OF THE INVENTION

The Figures illustrate exemplary embodiments of a binder apparatus and an assembly including the same. Based on the foregoing, it is to be generally understood that the nomenclature used herein is simply for convenience and the terms used to describe the invention should be given the broadest meaning by one of ordinary skill in the art.

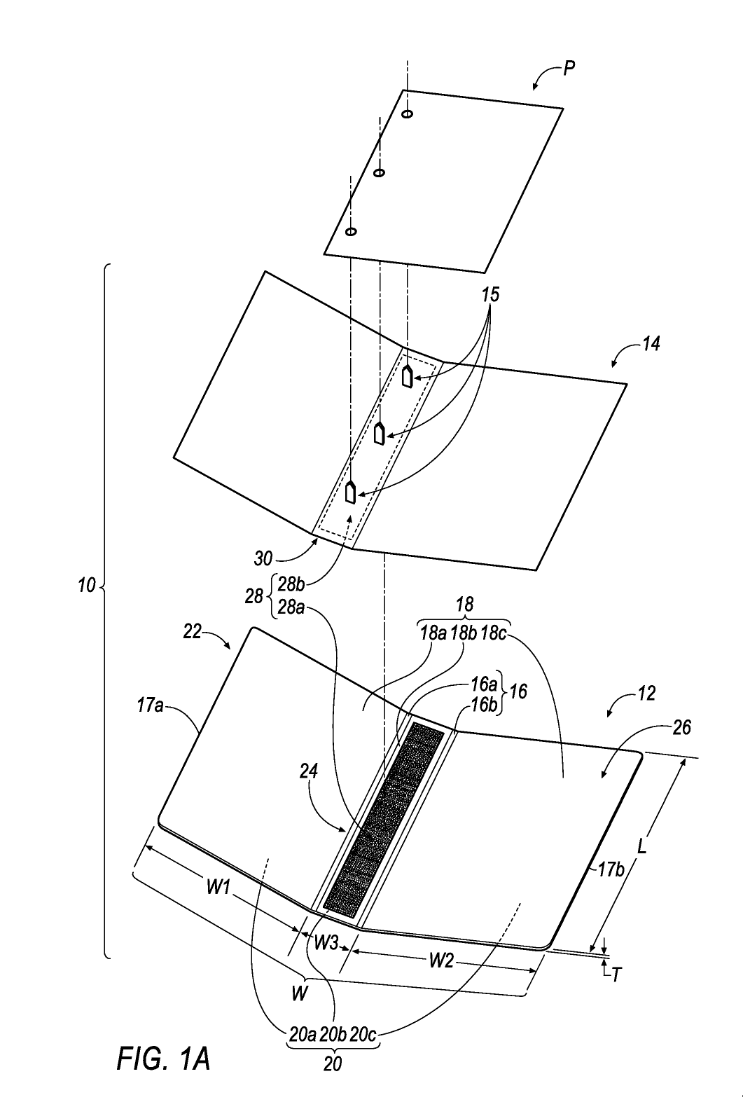

Referring to FIGS. 1A-3B, an assembly 10 including a binder 12 and at least one member 14 is shown. The at least one member 14 is/are removably-attached to the binder 12. In an implementation, the at least one member 14 may be at least one folder.

The binder 12 may be defined by a length, L. When arranged in an open orientation (as seen in FIGS. 1A-1B), the binder 12 may be defined by a width, W. As seen in FIGS. 1A-1B, the binder 12 may be defined by a thickness, T.

The binder 12 may be formed with or include one or more hinges 16. In an implementation, the one or more hinges 16 may be referred to as one or more “living hinges;” in an implementation, the thickness, T, may be reduced along one or more portions of the length, L, of the binder 12 to thereby define the one or more living hinges 16.

In an implementation, the binder 12 may include a first hinge 16a and a second hinge 16b. The first hinge 16a may be arranged at a first distance/width, W1, away from a first edge 17a of the binder 12. The second hinge 16b may be arranged at a second distance/width, W2, away from a second edge 17b of the binder 12. The first hinge 16a and the second hinge 16b may be spaced apart by a third distance/width, W3. In an implementation, the first distance/width, W1, may be approximately equal to the second distance/width, W2.

Referring to FIGS. 1A-1B, the binder 12 includes an interior surface portion 18 and an exterior surface portion 20. The first hinge 16a and the second hinge 16b separates the interior surface portion 18 to include a first interior surface portion 18a, a second interior surface portion 18b and a third interior surface portion 18c. The first hinge 16a and the second hinge 16b separates the exterior surface portion 20 to include a first exterior surface portion 20a, a second exterior surface portion 20b and a third exterior surface portion 20c.

The first interior surface portion 18a and the first exterior surface portion 20a may generally define a front cover portion 22 of the binder 12. The second interior surface portion 18b and the second exterior surface portion 20b may generally define a spine portion 24 of the binder 12. The third interior surface portion 18c and the third exterior surface portion 20c may generally define a rear cover portion 26 of the binder 12.

A fastener 28 is utilized for removably-securing the at least one folder 14 to the binder 12. The fastener 28 includes a first fastener portion 28a that is connected to the binder 12 and a second fastener portion 28b that is connected to the at least one folder 14. Connection of either of the first fastener portion 28a to the binder 12 and the second fastener portion 28b to the at least one folder 14 may be accomplished using, for example, an adhesive or a threaded connection.

In an implementation, the first fastener portion 28a may be secured to interior surface portion 18 of the binder 12. In an example, the first fastener portion 28a may be secured to the second interior portion 18b of the binder 12 thereby arranging the first fastener portion 28a along the spine portion 24 of the binder 12. In an example, the second fastener portion 28b may be secured to an exterior surface portion 30 of the at least one folder 14 defining, for example, a spine portion of the at least one folder 14.

The first fastener portion 28a may include any desirable geometry. In an embodiment, the first fastener portion may include a length dimension approximately equal to the length, L, of the binder 12 and a width dimension approximately equal to the third width, W3, of the binder 12 that extends between the first hinge 16a and the second hinge 16b.

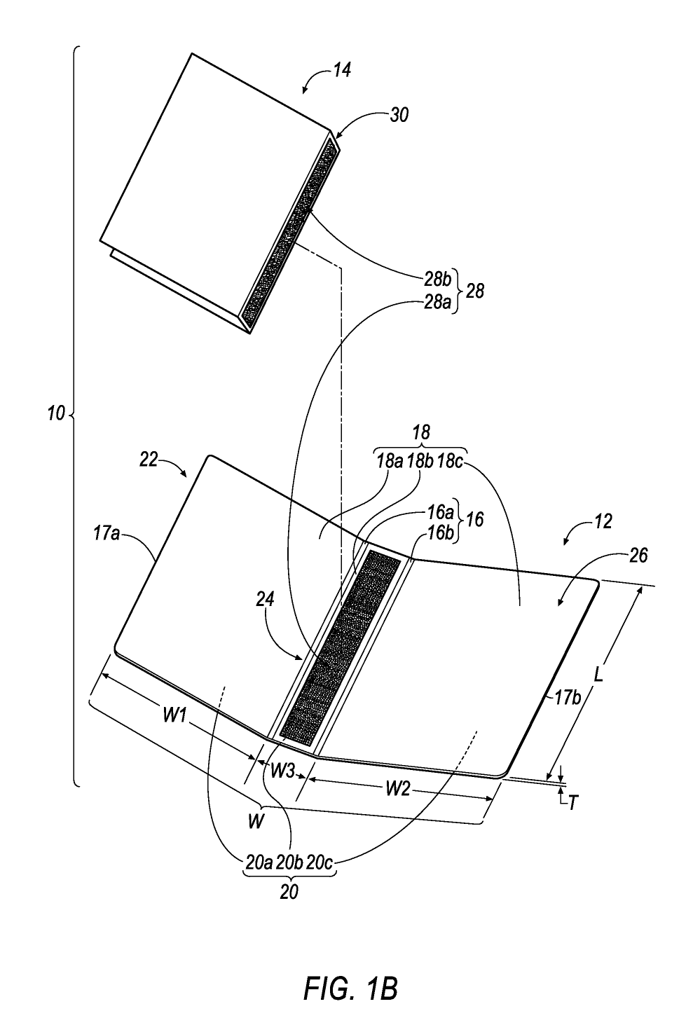

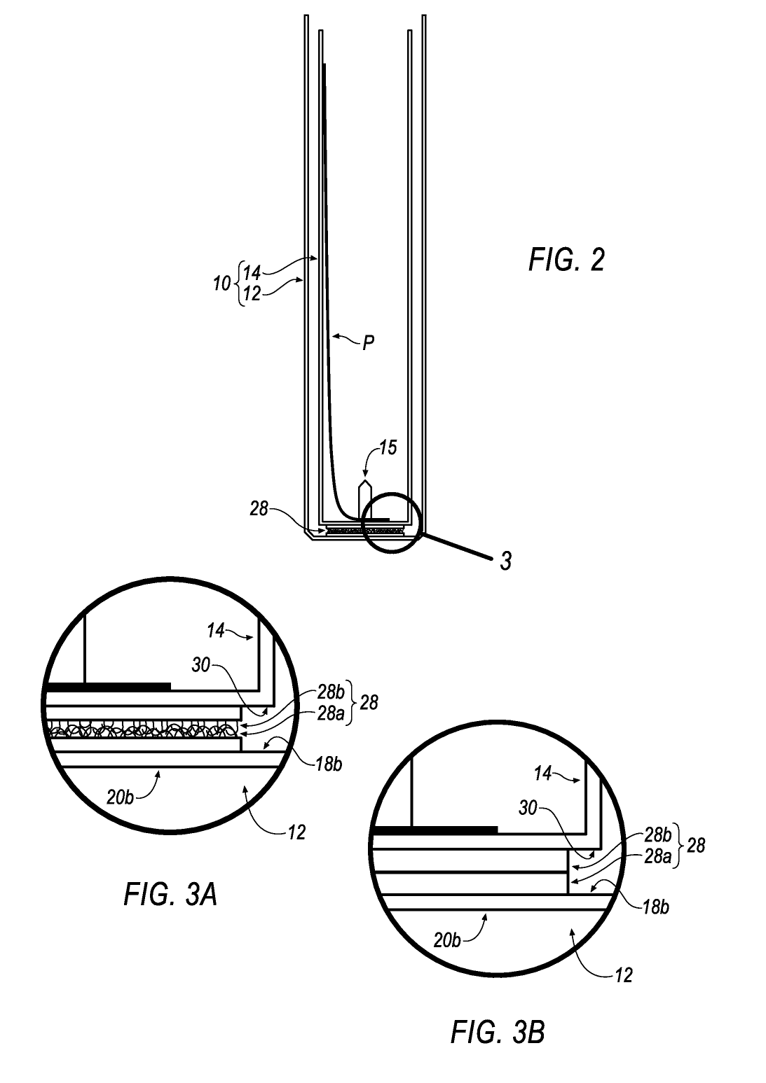

Referring to FIGS. 2-3A, in an implementation, one of the first fastener portion 28a and the second fastener portion 28b may include a hook portion whereas the other of the first fastener portion 28a and the second fastener portion 28b may include a loop portion. Therefore, the fastener 28 may be referred to as a “hook-and-loop fastener,” which is commercially available under the tradename VELCRO®.

Although an embodiment of the fastener 28 may be a hook-and-loop fastener as seen in FIG. 3A, the fastener 28 is not limited to a hook-and-loop fastener. For example, as seen in FIG. 3B, in an embodiment, the first fastener portion 28a may include a first magnet portion, and, the second fastener portion 28b may include a second magnet portion. Upon arranging, for example, the north pole of the first magnet portion 28a proximate the south pole of the second magnet portion 28b, the first and second magnet portions 28a, 28b may be attracted to one another thereby removably-coupling the binder 12 to the at least one folder 14.

Functionally, the at least one folder 14 may include one or more clasp portions 15 for retaining any desirable workpiece, such as, for example, one or more units of loose-leaf paper, P (see, e.g., FIGS. 1A, 2). Although one or more clasp portions 15 are shown for retaining one or more units of loose-leaf paper, P, the at least one folder 14 is not limited to the illustrated embodiment; for example, the at least one folder 14 may include one or more pockets for retaining one or more units of loose-leaf paper, P. The at least one folder 14 may include a material (such as, e.g., paperboard) that is more rigid than the one or more units of loose-leaf paper, P; therefore, when secured by the at least one folder 14, the one or more units of loose-leaf paper, P, is/are less prone to being damaged (e.g., folded, creased, stained with a liquid, etc.).

Functionally, as seen in FIG. 2, the binder 12 may contain the at least one folder 14, and, if the folder 14 contains the one or more units of loose-leaf paper, P, as described above, the binder 12 may be said to contain the one or more units of loose-leaf paper, P. The binder 12 may include a material (such as, e.g., cardboard) that is more rigid than the at least one folder 14; therefore, when secured by the binder 12, the at least one folder 14 (and the contents, such as, for example, loose-leaf paper, P, contained therein) is/are less prone to being damaged (e.g., folded, creased, stained with a liquid, etc.).

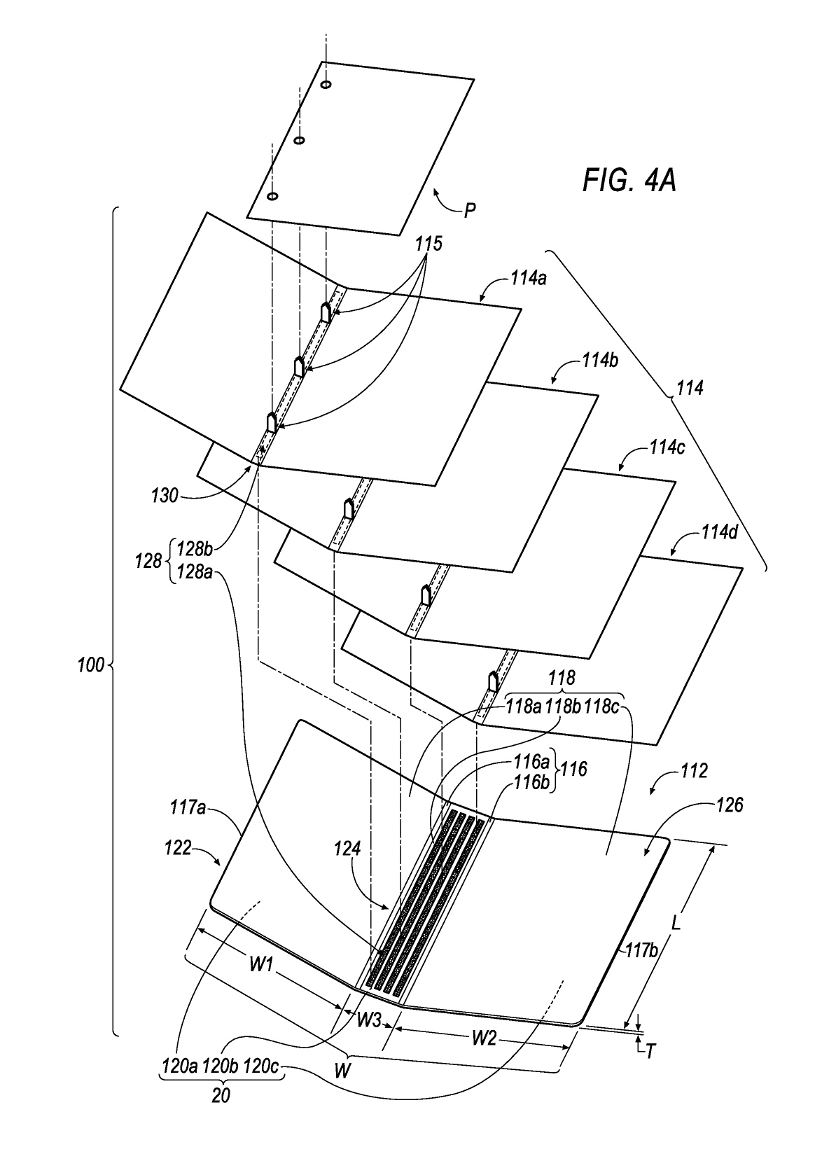

Referring to FIGS. 4A-6B, an assembly 100 including a binder 112 and at least one member 114 is shown. The at least one member 114 is/are removably-attached to the binder 112. In an implementation, the at least one member 114 may be at least one folder 114.

Any desirable amount of folders 114 may be included in the assembly 100. For example, an embodiment the assembly 100 may include four folders (i.e., the at least one folder 114 includes a first folder 114a, a second folder 114b, a third folder 114c and a fourth folder 114d).

The binder 112 may be defined by a length, L. When arranged in an open orientation (as seen in FIGS. 4A-4B), the binder 112 may be defined by a width, W. As seen in FIGS. 4A-4B, the binder 112 may be defined by a thickness, T.

The binder 112 may be formed with or include one or more hinges 116. In an implementation, the one or more hinges 116 may be referred to as one or more “living hinges;” in an implementation, the thickness, T, may be reduced along one or more portions of the length, L, of the binder 112 to thereby define the one or more living hinges 116.

In an implementation, the binder 112 may include a first hinge 116a and a second hinge 116b. The first hinge 116a may be arranged at a first distance/width, W1, away from a first edge 117a of the binder 112. The second hinge 116b may be arranged at a second distance/width, W2, away from a second edge 117b of the binder 112. The first hinge 116a and the second hinge 116b may be spaced apart by a third distance/width, W3. In an implementation, the first distance/width, W1, may be approximately equal to the second distance/width, W2.

Referring to FIGS. 4A-4B, the binder 112 includes an interior surface portion 118 and an exterior surface portion 120. The first hinge 116a and the second hinge 116b separates the interior surface portion 118 to include a first interior surface portion 118a, a second interior surface portion 118b and a third interior surface portion 118c. The first hinge 116a and the second hinge 116b separates the exterior surface portion 120 to include a first exterior surface portion 120a, a second exterior surface portion 120b and a third exterior surface portion 120c.

The first interior surface portion 118a and the first exterior surface portion 120a may generally define a front cover portion 122 of the binder 112. The second interior surface portion 118b and the second exterior surface portion 120b may generally define a spine portion 124 of the binder 112. The third interior surface portion 118c and the third exterior surface portion 120c may generally define a rear cover portion 126 of the binder 112.

A plurality of fasteners 128 are utilized for removably-securing the at least one folder 114 to the binder 112. Each fastener of the plurality of fasteners 128 includes a first fastener portion 128a that is connected to the binder 112 and a second fastener portion 128b that is connected to the at least one folder 114. Connection of either of the first fastener portion 128a to the binder 112 and the second fastener portion 128b to the at least one folder 114 may be accomplished using, for example, an adhesive or a threaded connection.

In an implementation, the first fastener portion 128a may be secured to interior surface portion 118 of the binder 112. In an example, the first fastener portion 128a may be secured to the second interior portion 118b of the binder 112 thereby arranging the first fastener portion 128a along the spine portion 124 of the binder 112. In an example, the second fastener portion 128b may be secured to an exterior surface portion 130 of the at least one folder 114 defining, for example, a spine portion of the at least one folder 114.

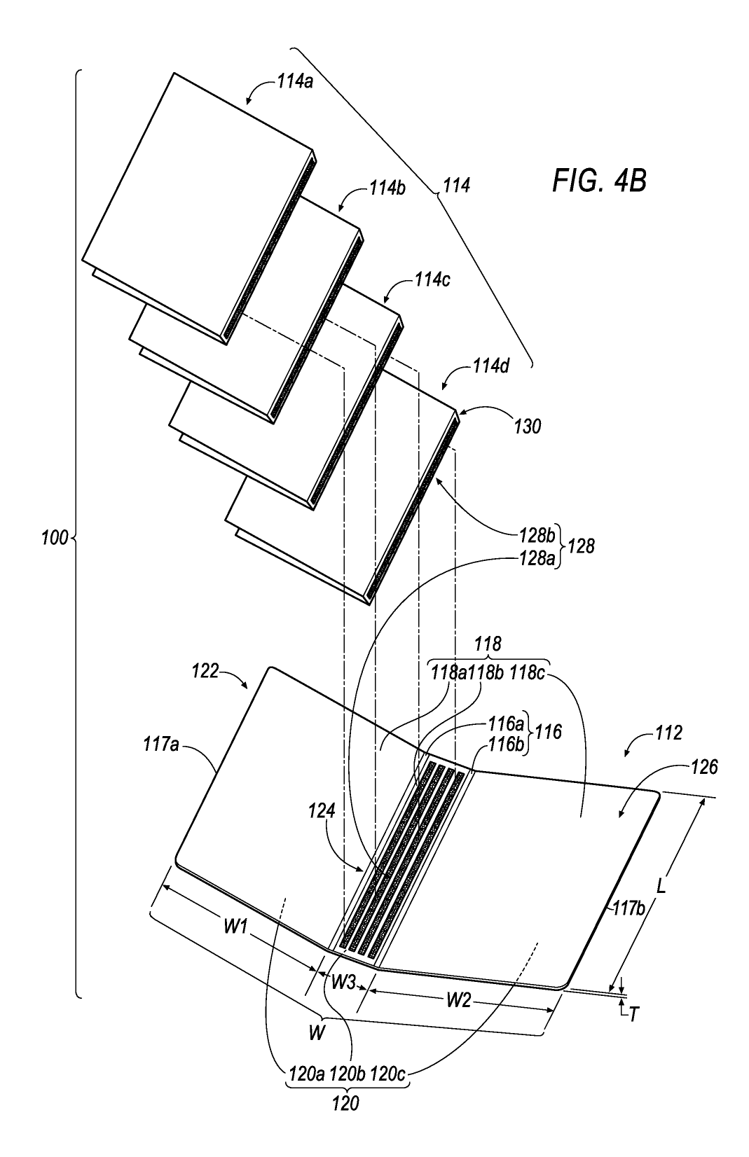

The first fastener portion 128a may include any desirable geometry. In an embodiment, the first fastener portion 128a may include a length dimension substantially equal to the length, L, of the binder 112 and a width dimension that is less than the third distance/width, W3, in order to accommodate a plurality (e.g., four) of first fastener portions 128a arranged upon the spine portion 124 of the binder 12. The plurality of first fastener portions 128a may correspond to an amount of folders (e.g., four folders 114a-114d) of the plurality of folders 114 included in the assembly 100. Although a plurality of first fastener portions 128a are shown in FIGS. 4A-5, a single first fastener portion including a substantially similar dimension as that of the first fastener portion 28a of FIGS. 1A-2 may be adequate for removably-securing the plurality of folders 114 to the binder 112.

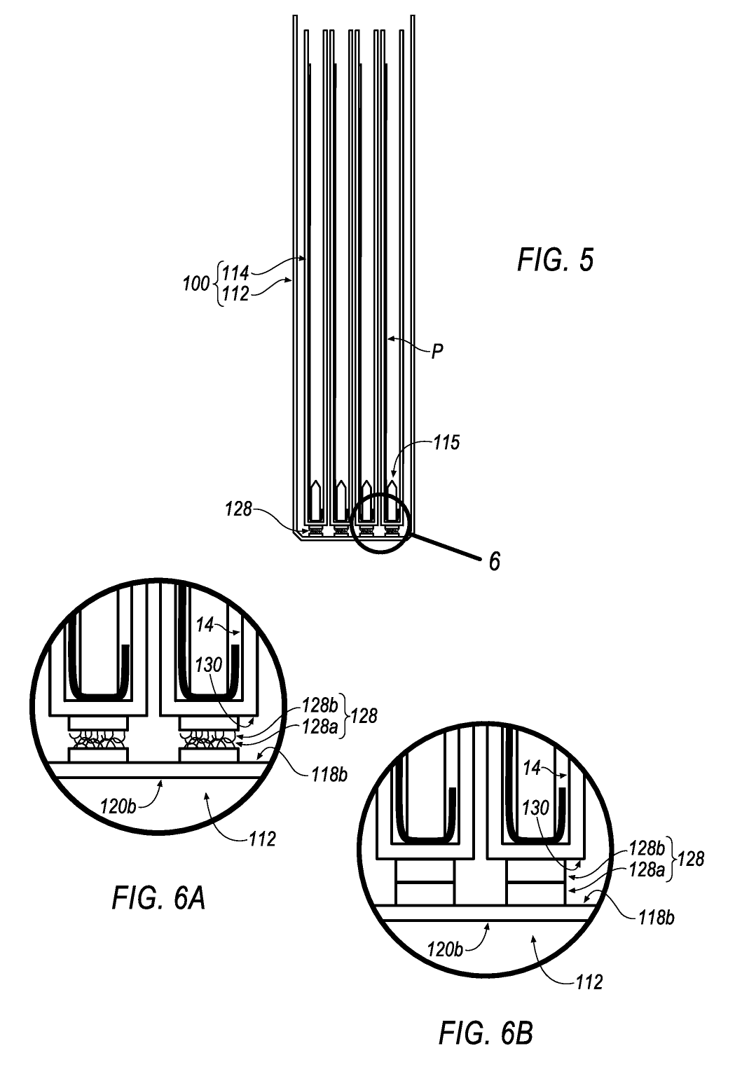

Referring to FIGS. 5-6A, in an implementation, one of the first fastener portion 128a and the second fastener portion 128b may include a hook portion whereas the other of the first fastener portion 128a and the second fastener portion 128b may include a loop portion. Therefore, the fastener 128 may be referred to as a “hook-and-loop fastener,” which is commercially available under the tradename VELCRO®.

Although an embodiment of the fastener 128 may be a hook-and-loop fastener as seen in FIG. 6A, the fastener 128 is not limited to a hook-and-loop fastener. For example, as seen in FIG. 6B, in an embodiment, the first fastener portion 128a may include a first magnet portion, and, the second fastener portion 128b may include a second magnet portion. Upon arranging, for example, the north pole of the first magnet portion 128a proximate the south pole of the second magnet portion 128b, the first and second magnet portions 128a, 128b may be attracted to one another thereby removably-coupling the binder 112 to the at least one folder 114.

Functionally, the at least one folder 114 may include one or more clasp portions 115 for retaining any desirable workpiece, such as, for example, one or more units of loose-leaf paper, P (see, e.g., FIGS. 4A and 5). Although one or more clasp portions 115 are shown for retaining one or more units of loose-leaf paper, P, the at least one folder 114 is not limited to the illustrated embodiment; for example, the at least one folder 114 may include one or more pockets for retaining one or more units of loose-leaf paper, P. The at least one folder 114 may include a material (such as, e.g., paperboard) that is more rigid than the one or more units of loose-leaf paper, P; therefore, when secured by the at least one folder 114, the one or more units of loose-leaf paper, P, is/are less prone to being damaged (e.g., folded, creased, stained with a liquid, etc.).

Functionally, as seen in FIG. 5, the binder 112 may contain the at least one folder 114, and, if the folder 114 contains the one or more units of loose-leaf paper, P, as described above, the binder 112 may be said to contain the one or more units of loose-leaf paper, P. The binder 112 may include a material (such as, e.g., cardboard) that is more rigid than the at least one folder 114; therefore, when secured by the binder 112, the at least one folder 114 (and the contents, such as, for example, loose-leaf paper, P, contained therein) is/are less prone to being damaged (e.g., folded, creased, stained with a liquid, etc.).

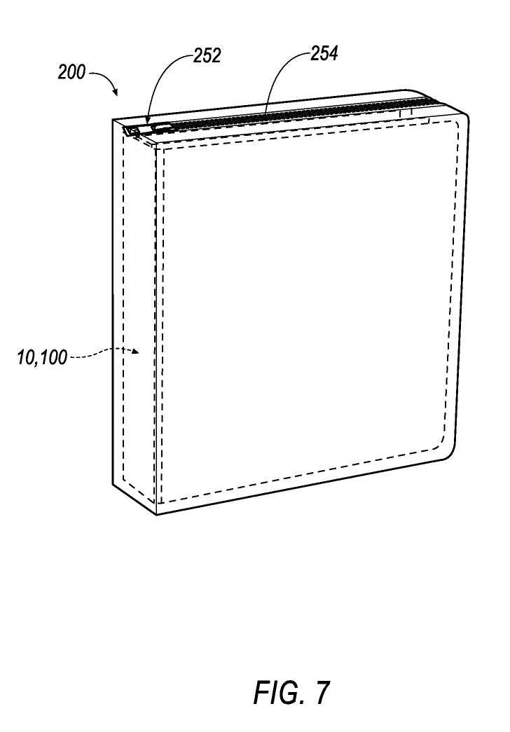

Referring to FIG. 7, the assembly 10, 100 may include a covering or webbing 200. The covering or webbing 200 may include a closure 252 such as, for example, a zipper.

The covering or webbing 200 may be secured to the exterior surface portion 20, 120 of the binder 12, 112. As seen in FIG. 7, when the binder 12, 112 is arranged in a closed orientation (such that the first interior surface portion 18a, 118a is arranged in an opposing relationship with respect to the third interior surface portion 18c, 118c), the closure 252 may close-out a slit or opening 254 formed by the covering or webbing 250. Functionally, the covering or webbing 200 may include a wear-resistant and/or liquid-resistant material that protects one or more of the binder 12, 112 and the at least one folder 14, 114 from the surrounding environment.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. An apparatus, comprising:
a binder including:
a front cover portion, a spine portion and a rear cover portion, wherein the front cover portion is connected to the spine portion by a first hinge, wherein the rear cover portion is connected to the spine portion by a second hinge, wherein each of the front cover portion, the spine portion and the rear cover portion define an interior surface portion and an exterior surface portion of the binder; and
at least one first fastener portion of a fastener arranged upon the interior surface portion of the binder, wherein the at least one first fastener portion of the fastener is arranged upon the spine portion of the binder.

2. The apparatus according to claim 1, wherein the fastener is a hook-and-loop fastener.

3. The apparatus according to claim 2, wherein the at least one first fastener portion is a hook portion of the hook-and-loop fastener.

4. The apparatus according to claim 2, wherein the at least one first fastener portion is a loop portion of the hook-and-loop fastener.

5. The apparatus according to claim 1, wherein the fastener is a magnet.

6. The apparatus according to claim 5, wherein the at least one first fastener portion is a north pole of the magnet.

7. The apparatus according to claim 5, wherein the at least one first fastener portion is a south pole of the magnet.

8. The apparatus according to claim 1 further comprising:
a webbing secured to the exterior surface portion of the binder for enclosing the binder.

9. The apparatus according to claim 8, wherein the webbing is a wear-resistant material.

10. The apparatus according to claim 8, wherein the webbing is a liquid-resistant material.

11. The apparatus according to claim 8, wherein the webbing forms an opening that provides access to the binder.

12. The apparatus according to claim 11, wherein the webbing includes a closure arranged along the opening for providing selective access to the binder that is enclosed by the webbing.

13. An assembly, comprising:
a binder including:
a front cover portion, a spine portion and a rear cover portion, wherein the front cover portion is connected to the spine portion by a first hinge, wherein the rear cover portion is connected to the spine portion by a second hinge, wherein each of the front cover portion, the spine portion and the rear cover portion define an interior surface portion and an exterior surface portion of the binder,
at least one first fastener portion of a fastener arranged upon the interior surface portion of the binder, wherein the at least one first fastener portion of the fastener is arranged upon the spine portion of the binder; and
at least one folder including
an exterior surface portion, and
at least one second fastener portion of the fastener arranged upon the exterior surface portion of the at least one folder, wherein the at least one fastener removably-connects the at least one folder to the binder.

14. The assembly according to claim 13, wherein the fastener is a hook-and-loop fastener.

15. The assembly according to claim 14, wherein the at least one first fastener portion is a hook portion of the hook-and-loop fastener, wherein the at least one second fastener portion is a loop portion of the hook-and-loop fastener.

16. The assembly according to claim 14, wherein the at least one first fastener portion is a loop portion of the hook-and-loop fastener, wherein the at least one second fastener portion is a hook portion of the hook-and-loop fastener.

17. The assembly according to claim 13, wherein the fastener is a magnet.

18. The assembly according to claim 17, wherein the at least one first fastener portion is a north pole of the magnet, wherein the at least one second fastener portion is a south pole of the magnet.

19. The assembly according to claim 17, wherein the at least one first fastener portion is a south pole of the magnet, wherein the at least one second fastener portion is a north pole of the magnet.

20. The assembly according to claim 13 further comprising:
a webbing secured to the exterior surface portion of the binder for enclosing the binder, wherein the webbing includes one or more of a wear-resistant material and a liquid-resistant material, wherein the webbing forms an opening that provides access to the binder and the at least one folder, wherein the webbing includes a closure arranged along the opening for providing selective access to the binder and the at least one folder that are enclosed by the webbing.
